(19) United States
(12) Patent Application Publication
(10) Pub. No.: US 2009/0083828 A1
(43) Pub. Date: Mar. 26, 2009

(54) METHOD OF ARMING-DISARMING SECURITY PANEL OVER UN-ENCRYPTED COMMUNICATION PATHS

(75) Inventors: Piotr Romanczyk, Melville, NY (US); William R. Blum, Huntington Station, NY (US); Phillip J. Ferro, North Massapequa, NY (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/861,370

(22) Filed: Sep. 26, 2007

(51) Int. Cl. G06F 17/00

(52) U.S. Cl. 726/1

(57) ABSTRACT

A method and system for remotely controlling a security panel of a security alarm system over un-encrypted communication paths are provided. In one aspect, a message is received in plain text over un-encrypted communication path, for example, from a remote device to control a security panel of a security system installed at a premise. The plain text message is correlated to a security panel command and the security panel command is sent to a security panel installed at the premise. The security panel executes the command and sends a confirmation status message. The status message is correlated to a second plain text message and communicated over the un-encrypted communication path to the remote device that initiated the command.

### FIELD OF THE INVENTION

The present disclosure relates to security systems and more particularly to communicating with security systems securing a premise over un-encrypted communication links.

### BACKGROUND OF THE INVENTION

Home and business security and/or alarm systems such as Total Connect suite of digital communications services from Honeywell allow consumers to utilize the Internet, PDAs, cell phones, etc., to communicate with security systems at their homes or businesses, for instance, by providing remote software applications that run on such remote devices. Some or all communications functionalities such as arming and/or disarming a security panel from such remote software applications require transmitting user's security code over communication links. For example, Total Connect application generally uses AES (Advanced Encryption Standard) encryption standard to pass data to or from a security panel.

However, one of possible ways to remotely communicate with a security panel is to use SMS (Short Message Service) available from most cellular service providers. SMS messages are written in plain text (unencrypted) and can be intercepted, thereby exposing the sensitive messages to possibility of hacking and unauthorized use. Thus, what is desirable is to have a method for using SMS while ensuring secure transmission of the messages.

### BRIEF SUMMARY OF THE INVENTION

A method and system for remotely controlling a security panel of a security alarm system over un-encrypted communication paths are provided. The method in one aspect may comprise receiving a message in plain text over an un-encrypted communication path; correlating the plain text to a security panel command; sending the security panel command to a security panel installed at a premise; receiving a security panel status message associated with execution of the security panel command at the security panel; correlating the security panel status message to a second plain text message; and communicating the second plain text message over the un-encrypted communication path.

A system for remotely controlling a security panel of a security alarm system over un-encrypted communication paths, in one aspect, may comprise a database having a plurality of plain text to security panel command mappings and a processor operable to receive a message in plain text over un-encrypted communication path. The processor may be further operable to look up the database to correlate the plain text to a security panel command and to send the correlated security panel command to a security panel installed at a premise. The processor may be further operable to receive a security panel status message associated with execution of the security panel command at the security panel and to map the security panel status message to a second plain text message from the database. The processor may be further operable to communicate the second plain text message over the un-encrypted communication path.

A program storage device readable by a machine, tangibly embodying a program of instructions executable by the machine to perform the above-described method steps may be also provided.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 is a block diagram illustrating the architectural overview of communicating messages on unencrypted communication links in one embodiment of the present disclosure.

FIG. 2 is a flow diagram illustrating the method of communicating messages on unencrypted communication links in one embodiment of the present disclosure.

### DETAILED DESCRIPTION

In one embodiment of the present disclosure, a method is proposed to replace arming-disarming commands, which include user passcode and command number, with user defined English phrases. Arming-disarming commands would look like a part of regular conversation between communicating parties for anybody who would want to intercept those messages.

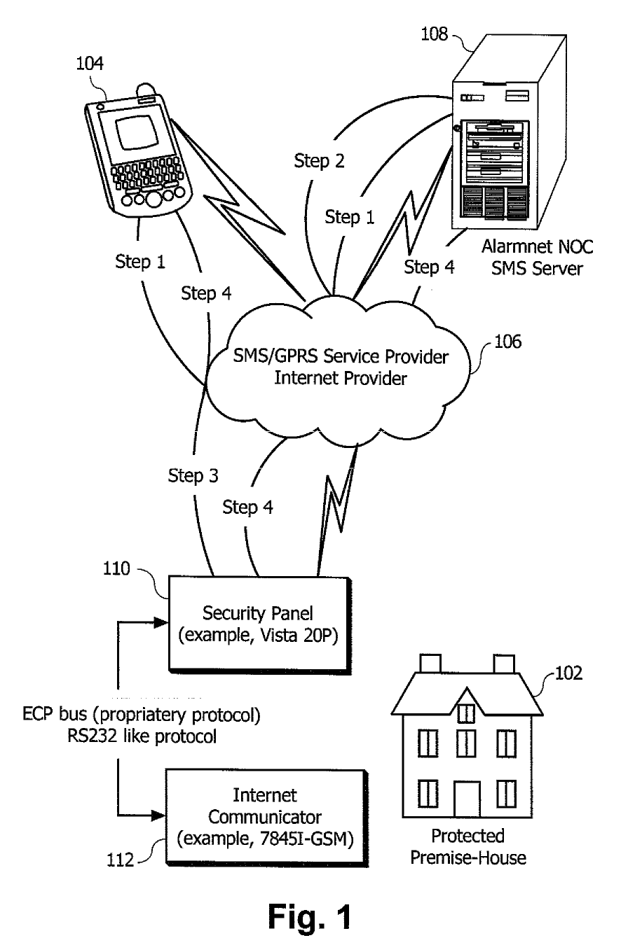

FIG. 1 is a block diagram illustrating the architectural overview of communicating messages on unencrypted communication links in one embodiment of the present disclosure. A user may access a security system control panel at a remote premise 102 utilizing a device 104. The device 104 may be any device that is enabled to communicate for instance, over the Internet, with the security system at a remote premise 102. Examples of such devices may include but are not limited to, personal computers, laptops, portable devices such as personal digital assistants (PDAs), cellular telephones, BlackBerry™ or like. The devices include SMS messaging capabilities. The device 104 sends SMS message with English phrase to Short Code service to a service provide such as SMS/GPRS (General Packet Radio Service) service provider or Internet provider 106. Most SMS service providers offer the “Short Code” service, which enables user to send SMS messages to short codes rather than 10 digit phone numbers. For instance, AlarmNet SMS service registers “25276”, which on phone could be typed in as “ALARM”.

The message is sent via SMS capable phone or BlackBerry™ 104 or any other device capable of sending SMS messages. An example of message is “Honey are you home?”. SMS messages are sent in plain text and are not encrypted in transport.

Central security system service 108 such as AlarmNet service from Honeywell receives the SMS message and authenticates it. For instance, AlarmNet service checks that the source of the message, for example, source phone number, is pre-registered with AlarmNet service. Central security system service 108, for instance, may be any communications service that, for example, provides communications (wired and/or wireless) and network services to security/alarm systems installed in the covered geographic area.

The central security system service 108 looks up the source of the message, for example, the source phone number, for instance, from its database and identifies the target guarded premise (e.g., protected house) 102. The central alarm system service 108 decodes the English phrase to a corresponding security panel command. For example, each security panel of a security system serviced via the central alarm system service 108 may have a database of English phrases and corresponding security panel commands. The central alarm system service 108 decodes the phrase by looking up the database for the security panel being serviced. The received message, English phrase “Honey are you home?” is decoded to security panel command such as “arm” or “disarm” by looking up in AlarmNet database.

The target premise's security system control panel may have an Internet Communicator (such as Honeywell 7845i-GSM) associated with it. Internet Communicator is a device that enables the security control panel to communicate with other devices via the Internet. The central alarm system service 108 also initiates a secure session with the Internet Communicator (such as Honeywell 7845i-GSM) or like 112 that is connected to the security control panel 110 at guarded premises 102. The Internet Communicator (such as Honeywell 7845i-GSM) or like 112 at guarded premises 102 starts secure session to the central alarm system service 108 (e.g., AlarmNet Network Operating Center (NOC)) or like.

Once a session is established, virtual secure link is available between the central alarm system service 108 and security panel 110 at protected premise 102 via Internet Communicator or like 112. Security keypad command is sent to security panel (such as Vista 20P) 110. The security panel 110 executes the command, e.g., “arm” on the panel and sends confirmation of successful operation back to the central alarm system service 108 and the requesting device 104 via the Internet Service Provide or like 106.

The central alarm system service 108 receives the confirmation of successful execution of “arm” command, looks up in a database a corresponding English phrase for successfully carried out arm function. For instance, a corresponding English phrase to confirmation of “arm command may be “Yes I am”. The central alarm system service 108 codes the confirmation into the English phrase. Such phrases may be individually setup by the end user. An SMS message from the central alarm system service 108 with text “Yes I am” is sent to a phone number which initiated the command, that is, device at 104, providing the command confirmation to end user. For anybody with capability to “listen” to the SMS conversations, the exchange “Honey are you home?” and “Yes I am” should be meaningless.

Similarly, different commands and different status messages may be encoded and decoded to enable secure communication over the un-encrypted communications links such as the SMS. For instance, rather than sending a successful confirmation, the security panel 110 may send arm unsuccessful message to the central security system 108, which then encode this message to a pre-determined English phrase to be sent to the requesting device 104. In addition, a user interface may be made available for a user to configure the database of plain text to security panel command correlations or mappings.

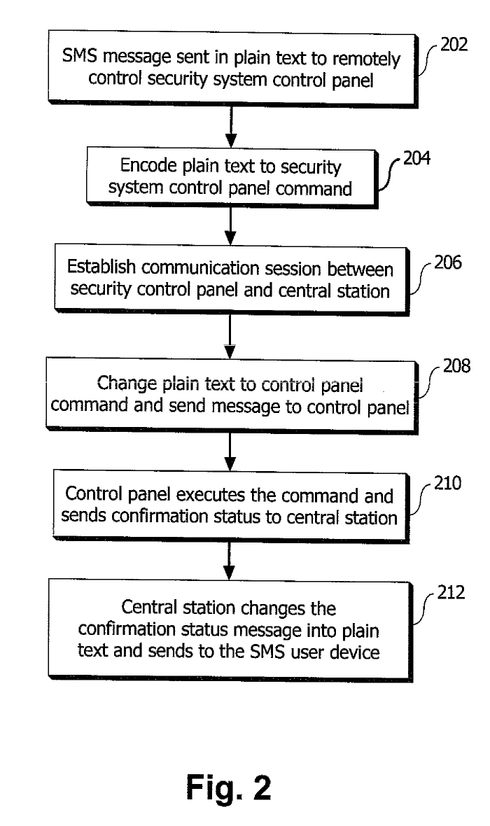

FIG. 2 is a flow diagram illustrating the method of communicating messages on unencrypted communication links in one embodiment of the present disclosure. At 202, an SMS message is sent from a user using a SMS capable device to control or command a remotely accessible security control panel guarding a premise. The message is typically transmitted via an SMS/RPTS service provider or Internet provider or like to a central security system service covering the network area of the guarded premise.

The plain text SMS message is received at the central security system. At the central security system, the plain text message is correlated to a security control panel functional command, such as arm or disarm as shown at step 204. The correlation or encoding is performed, for example, by using a database containing correlations of English phrases to security control panel commands. The correlations may be specific and unique to each security control panel or user, and may be predetermined or precoded by the users of the system.

At 206, a communication session for example using a virtual link is established between the security control panel or like at a premise securing the premise and the central security alarm service. The communication session is typically established via an Internet enabled device that connects to the security control panel for allowing the security control panel to communicate via the Internet. At 208, the central security alarm service sends the security keypad command to the security control panel or like. The security keypad command is the command that was coded from the English or plain text phrase received via the SMS message. At 210, the security control panel or like receives the command, for example, via the Internet enabled device and executes the command at the premise, and sends confirmation status back to the central security alarm service. At 212, the central security alarm service receives the confirmation status, correlates the confirmation status to a plain text, for example, an English phrase or unencrypted plain language, and sends the plain text to the device that requested the command to be performed.

The system and method of the present disclosure may be implemented and run on a general-purpose computer or computer system. The computer system may be any type of known or will be known systems and may typically include a processor, memory device, a storage device, input/output devices, internal buses, and/or a communications interface for communicating with other computer systems in conjunction with communication hardware and software, etc.

The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, server. A module may be a component of a device, software, program, or system that implements some “functionality”, which can be embodied as software, hardware, firmware, electronic circuitry, or etc.

The embodiments described above are illustrative examples and it should not be construed that the present invention is limited to these particular embodiments. For instance, the messaging protocol need not be limited to SMS, but may be in another protocol that transports without encrypting capabilities. Thus, various changes and modifications may be effected by one skilled in the art without departing from the spirit or scope of the invention as defined in the appended claims.

We claim:

1. A method of remotely controlling a security panel of a security alarm system over un-encrypted communication paths, comprising:
receiving a message in plain text over an un-encrypted communication path;
correlating the plain text to a security panel command;
sending the security panel command to a security panel installed at a premise;
receiving a security panel status message associated with execution of the security panel command at the security panel;
correlating the security panel status message to a second plain text message; and
communicating the second plain text message over the un-encrypted communication path.

2. The method of claim 1, wherein said correlating steps includes looking up a database comprising a plurality of plain text to security panel command correlations.

3. The method of claim 1, wherein the un-encrypted communication path includes SMS message path.

4. The method of claim 1, further including:
establishing a secure virtual channel to the security panel, wherein the step of sending the security panel command and the step of receiving the security panel status message is performed via the secure virtual channel.

5. The method of claim 1, further including:
enabling an end user to configure plain text to security panel command correlations.

6. The method of claim 1, wherein the security panel command includes a command to arm security system at the premise.

7. The method of claim 1, wherein the security panel command includes a command to disarm security system at the premise.

8. The method of claim 1, wherein said message in plain text is received from an Internet enabled device.

9. The method of claim 1, wherein said message in plain text is received from a portable device.

10. A system for remotely controlling a security panel of a security alarm system over un-encrypted communication paths, comprising:
a database having a plurality of plain text to security panel command mappings; and
a processor operable to receive a message in plain text over un-encrypted communication path and further operable to look up the database to correlate the plain text to a security panel command, the processor further operable to send the correlated security panel command to a security panel installed at a premise and receive a security panel status message associated with execution of the security panel command at the security panel, the processor further operable to map the security panel status message to a second plain text message from the database, and communicate the second plain text message over the un-encrypted communication path.

11. The system of claim 10, wherein the processor is further operable to establish a secure virtual link with the security panel at a premise for communicating one or more security panel commands.

12. The system of claim 10, wherein the un-encrypted communication path includes SMS messaging path.

13. The system of claim 10, wherein the processor receives the plain text message and sends the second plain text message to a remote portable device.

14. The system of claim 10, further including an interface enabled to allow a user to configure the database.

15. A program storage device readable by a machine, tangibly embodying a program of instructions executable by the machine to perform a method of remotely controlling a security panel of a security alarm system over un-encrypted communication paths, comprising:
receiving a message in plain text over an un-encrypted communication path;
correlating the plain text to a security panel command;
sending the security panel command to a security panel installed at a premise;
receiving a security panel status message associated with execution of the security panel command at the security panel;
correlating the security panel status message to a second plain text message; and
communicating the second plain text message over the un-encrypted communication path.
